(19) United States
(12) Patent Application Publication
(10) Pub. No.: US 2008/0113140 A1
(43) Pub. Date: May 15, 2008

(54) IDLER ROLLER ADHESIVE TAPE

(75) Inventor: Jaykumar Shah, Wayne, NJ (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: SCAPA NORTH AMERICA, Windsor, CT (US)

(21) Appl. No.: 11/936,670

(22) Filed: Nov. 7, 2007

Related U.S. Application Data
(60) Provisional application No. 60/865,037, filed on Nov. 9, 2006.

(51) Int. Cl. B32B 33/00; B32B 9/04

(52) U.S. Cl. 428/40.6; 428/41.3; 428/41.4; 428/41.5; 428/41.8

(57) ABSTRACT

A adhesive tape is having a first substrate layer, an adhesive layer, and a release layer. The first substrate layer has a first side and a second side, and the first substrate layer is embossed with a traction enhancing pattern. The adhesive layer is attached to the first layer side of the first substrate layer to adhere the tape to a surface. The adhesive layer does not leave substantial adhesive residue on the surface upon detachment of the adhesive tape from the surface. The release layer is on the second side of the first substrate layer to reinforce the substrate layer and to facilitate release of the adhesive layer from the release layer when the tape is overlapped on itself. The tape may be used effectively in converting industries to mask or protect idler rollers.

### RELATED APPLICATION

This application claims the benefit of and priority to U.S. Provisional Application Ser. No. 60/865,037, filed Nov. 9, 2006, the contents of which are incorporated by reference herein in its entirety.

### BACKGROUND

In the converting industries, grip tapes are commonly applied to carrier supporting rolls, also known as idler rollers, to provide an anti-slip surface and to protect the idler rollers. Conventional grip tapes are commonly silicone coated cloths coated on the other side with a pressure sensitive adhesive that binds when pressure is applied. Generally, the tape is cylindrically wound on itself for storage purposes. To prevent the tape from sticking to itself in this storage position, the pressure sensitive adhesive is protected by a release paper or film liner that is to be removed prior to application of the tape to the idler roller.

One problem with these tapes is the removal of the tapes from the idler rollers after a long period of usage. Adhesives used by the tapes leave residues on the idler rollers that is both time consuming and difficult for operators to clean. Another problem is the inconvenience associated with the removal of the release liner in order to apply the tape. Often, time is wasted and dispensers are needed to remove the release liners, making it inconvenient to unwind the tape and apply it simultaneously to an idler roller.

The present disclosure provides an adhesive tape with qualities that address the aforementioned problems as well as other disadvantages associated with conventional grip tapes.

### SUMMARY

According to an aspect of the present disclosure, an adhesive tape is provided, comprising a first substrate layer, an adhesive layer, and a release layer. The first substrate layer has a first side and a second side, and the first substrate layer is embossed with a traction enhancing pattern. The adhesive layer is attached to the first side of the first substrate layer to adhere the tape to a surface. The adhesive layer does not leave substantial adhesive residue on the surface upon detachment of the adhesive tape from the surface. The release layer is on the second side of the first substrate layer to reinforce the substrate layer and to facilitate release of the adhesive layer from the release layer when the tape is overlapped on itself.

According to another aspect of the present disclosure, the adhesive tape further includes a second substrate layer sandwiched between and attached to the first substrate layer and the adhesive layer. The second substrate layer provides additional mechanical strength and/or additional heat resistance to the adhesive tape.

In exemplary implementations, the second substrate layer is a different material than the material of the first substrate layer.

### DRAWINGS

The above-mentioned features and objects of the present disclosure will become more apparent with reference to the following description taken in conjunction with the accompanying drawings wherein like reference numerals denote like elements and in which:

FIG. 1 is a sectional view of an adhesive tape overlapped on itself.

FIG. 2 is a top-down sectional view of an adhesive tape.

### DETAILED DESCRIPTION

The present disclosure relates to an improved adhesive tape that may be applied to a surface to provide traction and to protect the surface from abrasion and other damages from materials placed thereon. In particular, an adhesive tape is disclosed that may be applied to idler rollers to provide a non-skid surface as well as mask or protect the idler rollers. Additionally, the present disclosure provides a high-tack, pressure-sensitive adhesion surface that, when applied to idler rollers or the like and extensively used, is easily removable without the necessity of undue maintenance of the idler roller or the like to remove residual tape and adhesive.

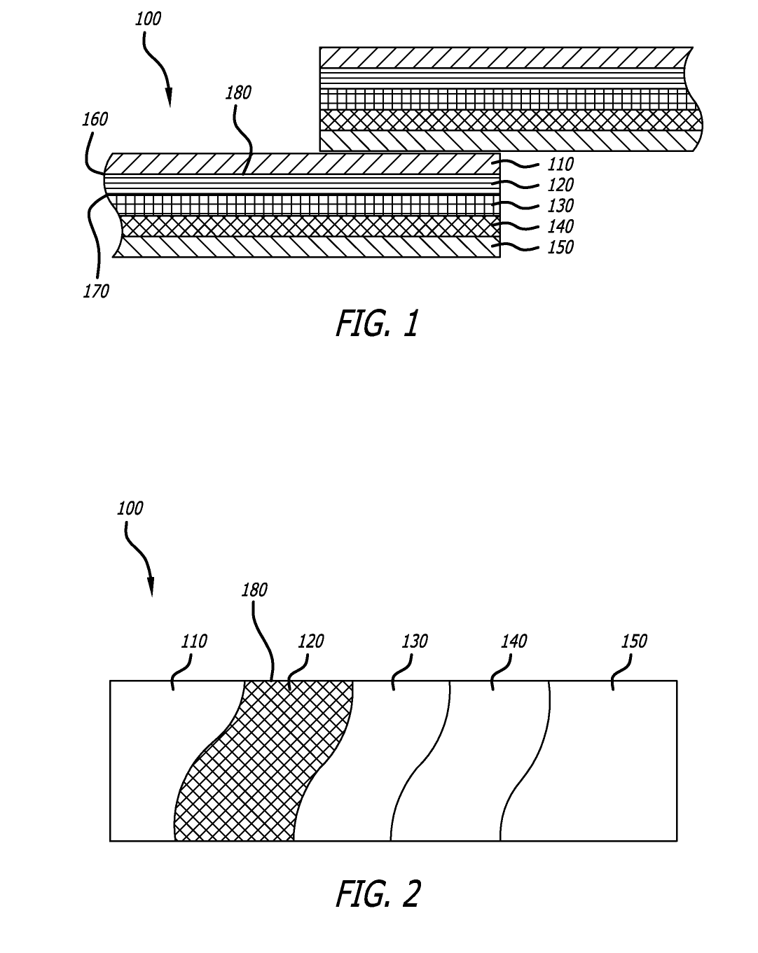

In FIG. 1, an adhesive tape 100 is shown. According to exemplary implementations, adhesive tape 100 comprises a plurality of layers including a release layer 110, a first substrate layer 120, an adhesive 130, a second substrate layer 140, and an adhesive layer 150. Multiple layers provide the adhesive tape with the mechanical strength needed during usage on a surface.

In one aspect of the present disclosure, an adhesive tape is provided, comprising a first substrate layer, an adhesive layer, and a release layer. The first substrate layer has a first side 170 and a second side 160, and the first substrate layer is embossed with a traction enhancing pattern 180. The adhesive layer is applied to the first side of the first substrate layer to adhere the tape to a surface. The adhesive layer does not leave substantial adhesive residue on the surface upon removal of the adhesive tape from the surface. The release layer is on the second side of the first substrate layer to facilitate release of the adhesive layer from the release layer when the tape is overlapped on itself, as shown in FIG. 1.

The topmost layer, release layer 110, provides a non-slip finish to enhance the traction provided by the adhesive tape 100. Release layer 110 may be made of materials based on silicone polymers, acrylic polymers, polymers based on polyvinyl octadecyl carbamate (PVODC), as well as other release materials well known in the art. The release characteristics may be varied by using different materials. The release layer 110 is applied to a first substrate layer 120 with conventional coating methods, for example, gravure, Meyer rod, and roll to roll coating methods.

Release layer 110 facilitates the release of the adhesive layer 150 from the release layer 110 when the tape is unwound from itself.

In exemplary implementations, release layer 110 allows the adhesive tape 100 to be easily unwound from a cylindrically wrapped storage position and be ready for application. For storage purposes, the adhesive tape is generally cylindrically wrapped with the adhesive tape overlapping itself, such that an adhesive layer adheres to a release coat layer. Release layer 110 allows the adhesive tape 100 to cleanly detach from itself while maintaining the adhesive on its adhesive layer 150. For a clean detachment, there is no substantial or measurable amount of adhesive residue left on the surface the adhesive is detached from. Without a release layer, the adhesive would cause the adhesive tape to stick to itself, making it hard to unwind the adhesive tape. Release layer 100 eliminates the need for a release paper or film liner.

Similarly, when the adhesive tape is applied to an idler roller surface, the adhesive tape may be wrapped around the roller multiple times, overlapping itself. Release layer 110 facilitates the release of the adhesive layer 150 from the release layer 110 when removal of the adhesive tape from the roller is desired.

In another aspect of the present disclosure, first substrate layer 120 is embossed, as shown in FIG. 2. Embossing first substrate layer 120 provides increased traction for materials contacting the outward surface, or the side with the release layer 110. The pattern, depth, and roughness of the traction enhancing pattern 180 may be varied depending on the desired coefficient of friction. Preferably, first substrate layer 120 is made from plastic films such as polyolefin, PVC, or polyester films. However, artisans will recognize equivalent materials, such as cloth and paper that may be used to achieve similar results. The first substrate layer 120 may also provide increased mechanical strength, heat resistance, and surface protecting qualities to the adhesive tape 100.

Surface protection includes protecting the surface from abrasion, impact, and/or corrosion as well as masking the surface from adhesives, inks, oils, and other substances that may contact the surface. Buildup of undesired substances on an adhesive tape masked surface may be eliminated by the removal of the adhesive tape masking the surface.

An adhesive 130 is located between second substrate layer 140 and first substrate layer 120. The adhesive 130 holds first substrate layer 120 and second substrate layer 140 together. In exemplary implementations, adhesive 130 is a high-tack laminating adhesive that maintains strong bonds between the first and second substrate layer. The adhesive may include high tack pressure sensitive or heat activated acrylic, silicone, rubber, or rubber-resin based polymers. Artisans will know and understand the composition of modified acrylic-based adhesive 130 in light of the purposes stated herein.

In a further aspect of the present disclosure, second substrate layer 140 provides additional mechanical strength and/or heat resistance to the adhesive tape 100. In exemplary implementations, second substrate layer 140 comprises a polyester film. Other materials, such as PVC, polyolefin films, polyamide films, and silicone coated cloths may also be used.

The first substrate layer 120 and a second substrate layer 140 may be made of different materials. This provides increased mechanical strength, improved heat resistance, and surface protecting qualities to the adhesive tape 100. Desired mechanical strength and surface protecting qualities of the adhesive tape may be obtained by varying the combination of materials used for the first substrate layer and the second substrate layer.

In another aspect of the present disclosure, adhesive layer 150 provides an adhesive surface that allows adhesive tape 100 to adhere to surfaces, such as an idler roller. In exemplary implementations, adhesive layer 150 is a high-tack modified acrylic, vinyl-acrylic, rubber-resin or silicone based removable pressure sensitive adhesive. Removable adhesives do not leave substantial adhesive residue on surfaces when the adhesive coated product is removed. Substantial adhesive residue is measurable or noticeable adhesive left on the surface. Pressure sensitive adhesive bonds to a surface, such as an idler roller surface, when pressure is applied, eliminating the need to use extra heat or water to make it stick. Artisans will know and understand the modification process for increasing tack in an adhesive, for example by adding non-acrylic tackifying resins, such as hydrocarbon resin, rosin ester, polyturpene resin, and other tackifying resins. Increased tack is needed when the product is applied on rough surfaces. Decreased tack may be used for smoother surfaces.

According to exemplary implementations, an adhesive tape is affixed to an idler roller. The tape is applied by pulling the tape from its cylindrically rolled storage position and wrapping it onto the idler roller surface. Once affixed, the adhesive tape provides traction for materials contacting the idler roller, protects the idler roller from heat and abrasion, and prevents buildup of adhesives, ink, and coatings onto the idler roller. The tape is usually changed after it loses friction and the capability fulfills its intended usage. The tape may be fully removed without the problem of substantial or excessive tape adhesive residue. The adhesive tape is removed by simply unwinding the tape from the idler roller. It may also be possible to reuse the tape for other applications that require less friction.

In addition to use on idler rollers, adhesive tape may be used for a variety of applications where surface traction and protection is desired. For example, adhesive tape may be used on skateboard decks, scooter decks, boat decks, stairs, windsurfer decks, and other surfaces where good traction is desired, such as preventing a user from slipping on the surface.

Generally, the adhesive tape is a flat continuous sheet, though the adhesive tape may also be cut as individual strips with different shapes and sizes depending on the surface that the adhesive tape is to be applied. The adhesive tape may also have other qualities such as being vibration and impact absorbing, heat resistant, waterproof, and elastic. Though the present disclosure focuses mainly on an adhesive tape with a first and second substrate layer, additional layers may be included in the adhesive tape for increased traction, mechanical strength, heat resistance, and other properties. Similarly, it is also possible for the adhesive tape to only have a first substrate layer with a release coat layer and an adhesive layer.

While the apparatus and method have been described in terms of what are presently considered to be the most practical and preferred exemplary implementations, it is to be understood that the disclosure need not be limited to the disclosed exemplary implementations. It is intended to cover various modifications and similar arrangements included within the spirit and scope of the claims, the scope of which should be accorded the broadest interpretation so as to encompass all such modifications and similar structures. The present disclosure includes any and all exemplary implementations of the following claims.

1. An adhesive tape comprising:
a first substrate layer having a first side and a second side, wherein the first substrate layer is embossed with a traction enhancing pattern; and
an adhesive layer attached to the first side of the first substrate layer for adhering the tape to a surface, wherein the adhesive layer does not leave substantial adhesive residue on the surface upon detachment of the adhesive tape from the surface; and
a release layer on the second side of the first substrate layer reinforcing the substrate layer and facilitating release of the adhesive layer from the release layer when the tape is overlapped on itself.

2. The adhesive tape of claim 1 further including a second substrate layer sandwiched between and attached to the first substrate layer and the adhesive layer providing at least one of an additional mechanical strength or additional heat resistance to the adhesive tape.

3. The adhesive tape of claim 1 wherein the first substrate layer is a PVC, polyester, polyolefin, silicone coated cloth, or paper material.

4. The adhesive tape of claim 1 wherein the adhesive layer is a pressure sensitive adhesive based on a rubber-resin polymer, acrylic polymer, vinyl-acrylic polymer, or silicone polymer.

5. The adhesive tape of claim 1 wherein the release layer is a silicone polymer, acrylic polymer, or polyvinyl octadecyl carbamate polymer.

6. The adhesive tape of claim 2 wherein the second substrate layer is a PVC, polyester, polyolefin, polyamide, or silicone coated cloth material.

7. The adhesive tape of claim 2 wherein the second substrate layer is a different material than the material of the first substrate layer.

8. The adhesive tape of claim 2 further including an adhesive attaching the first substrate layer to the second substrate layer, wherein the adhesive is one of a rubber-resin based pressure sensitive adhesive, acrylic based pressure sensitive adhesive, or heat activated adhesive.

9. An adhesive tape comprising:
a first substrate layer having a first side and a second side, the first substrate layer being a PVC, polyester, polyolefin, silicone coated cloth, or paper material, wherein the first substrate layer is embossed with a traction enhancing pattern; and
an adhesive layer attached to the first side of the first substrate layer for adhering the tape to a surface, the adhesive layer being a pressure sensitive adhesive based on a rubber-resin polymer, acrylic polymer, vinyl-acrylic polymer, or silicone polymer, wherein the adhesive layer does not leave substantial adhesive residue on the surface upon detachment of the adhesive tape from the surface; and
a release layer on the second side of the first substrate layer reinforcing the substrate layer and facilitating release of the adhesive layer from the release layer when the tape is overlapped on itself, wherein the release layer is a silicone polymer, acrylic polymer, or polyvinyl octadecyl carbamate polymer.

10. An adhesive tape comprising:
a first substrate layer having a first side and a second side, the first substrate layer being a PVC, polyester, polyolefin, silicone coated cloth, or paper material, wherein the first substrate layer is embossed with a traction enhancing pattern; and
an adhesive layer attached to the first side of the first substrate layer for adhering the tape to a surface, the adhesive layer being a pressure sensitive adhesive based on a rubber-resin polymer, acrylic polymer, vinyl-acrylic polymer, or silicone polymer, wherein the adhesive layer does not leave substantial adhesive residue on the surface upon detachment of the adhesive tape from the surface;
a release layer on the second side of the first substrate layer reinforcing the substrate layer and facilitating release of the adhesive layer from the release layer when the tape is overlapped on itself, wherein the release layer is a silicone polymer, acrylic polymer, or polyvinyl octadecyl carbamate polymer;
a second substrate layer sandwiched between and attached to the first substrate layer and the adhesive layer providing at least one of an additional mechanical strength or additional heat resistance to the adhesive tape, the second substrate layer being a PVC, polyester, polyolefin, polyamide, or silicone coated cloth material, wherein the second substrate layer is a different material than the material of the first substrate layer; and
an adhesive attaching the first substrate layer to the second substrate layer, wherein the adhesive is one of a rubber-resin based pressure sensitive adhesive, acrylic based pressure sensitive adhesive, or heat activated adhesive.
